(19) United States
(12) Patent Application Publication
(10) Pub. No.: US 2007/0094902 A1
(43) Pub. Date: May 3, 2007

(54) WIND RESISTANT MAGNETIC LETTER HOLDERS FOR LARGE SIGNS

(75) Inventor: Richard Joel Petrocy, Carteret, NJ (US)

Correspondence Address: STANLEY H. KREMEN, 4 LENAPE LANE, EAST BRUNSWICK, NJ, 08816, US

(73) Assignee: Universal Media Systems, Inc., Warren, NJ (US)

(21) Appl. No.: 11/553,803

(22) Filed: Oct. 27, 2006

Related U.S. Application Data
(60) Provisional application No. 60/596,978, filed on Nov. 2, 2005.

(51) Int. Cl. G09F 19/08

(52) U.S. Cl. 40/411

(57) ABSTRACT

A magnetic holder for letters appearing on a wall sign. A typical application would be for signs requiring halo glow lighting. With such a sign, the letter itself is unlit, and the wall is lit by soft lighting from behind the letter. Lighting could be accomplished with the use of a plurality of light emitting diodes (LED). The Present Invention comprises a mounting plate that is securely attached to the wall. The LED's, lighting circuitry, and magnets are securely fastened to the mounting plate. The letter is a hollow magnetic channel letter that is slightly larger than the mounting plate. The letter is positioned over the mounting plate, and is held in position by the magnets. The letter may be manually positioned on the plate for proper alignment.

### BACKGROUND OF THE INVENTION

The fabrication of a sign where halo lit channel letters are mounted to a building wall or surface normally requires unsightly fasteners either in the front or on the sides of each letter. Furthermore, such a sign usually requires there to be electric wires visible between the letters. With halo lighting, the wall rather than the letters are lit. Also, such signs are traditionally vulnerable to high winds and to being struck by flying debris.

### SUMMARY OF THE INVENTION

The Present Invention is used in a signs comprising standard production hollow channel letters. The letter comprises a front solid face, and a channel in the rear of the letter. This letter is to be used in a sign attached to a wall. The letter is separated from the wall by a distance. Illumination comes from behind the rear surface of the letter. Therefore, it is the wall that is illuminated and not the letter. This is called a “halo glow.” Within the channel resides a lexan back mounting plate that is a clear plastic model of the letter sized slightly smaller than the letter itself and sized to fit into the channel. The actual size of the mounting plate with respect to the letter depends upon how much adjustability in the position of the letter is desired. If the letter is made of a non-magnetic material (such as plastic), then it must be made to be magnetic (e.g., by gluing a sheet of galvanized metal inside the channel to the inside surface of the letter). All of the circuitry, magnets, and the LED lights reside on the mounting plate. When fully assembled, the mounting plate fits completely into the channel so that nothing protrudes from the letter itself.

On the inside of the mounting plate, there is a series of LED's for lighting. However, this is not necessary. Lighting is not required. Only the magnets are required. The mounting plates all have to be mounted on the wall with spacers. The mounting plate has holes for the spacers, but the spacers are not included in the mounting plate assembly. The spacers are hollow cylinders similar to washers. Preferably, they would be adapted to receive machine screws. They can be plastic or metal. Spacers are mounted directly to the wall. Then, the mounting plate is fastened to the spacers by screws that fit into the mounting plate spacer holes and screw into the spacers. Therefore, the mounting plate is directly mounted onto the wall.

It is important that unsightly screws do not show in the front or on the sides of the letter. One cannot get a screw driver to fit behind the letter to fasten the letter to the wall, especially with other letters close to that letter. The purpose of the magnets is to firmly attach the letter to the mounting plate, and not to attach the mounting plate to the wall. The mounting plate is fastened to the wall and held by the spacers. An advantage of using magnets is that the position of the letter is adjustable. For example, if the mounting plate is fastened to a brick wall, the position of the letter might be skewed. However, with the magnets, this is correctable by hand.

This system has the following advantages:
1. It eliminates the need for side fasteners.
2. The letters are magnetically mounted to the mounting plate—not securely fastened to the wall.
3. The letters are easily aligned (positioned).

### BRIEF DESCRIPTION OF THE DRAWINGS

FIG. 1 is a side elevational view of two letter assemblies mounted to a wall using the Present Invention. The letter assembly on the right is fully assembled.

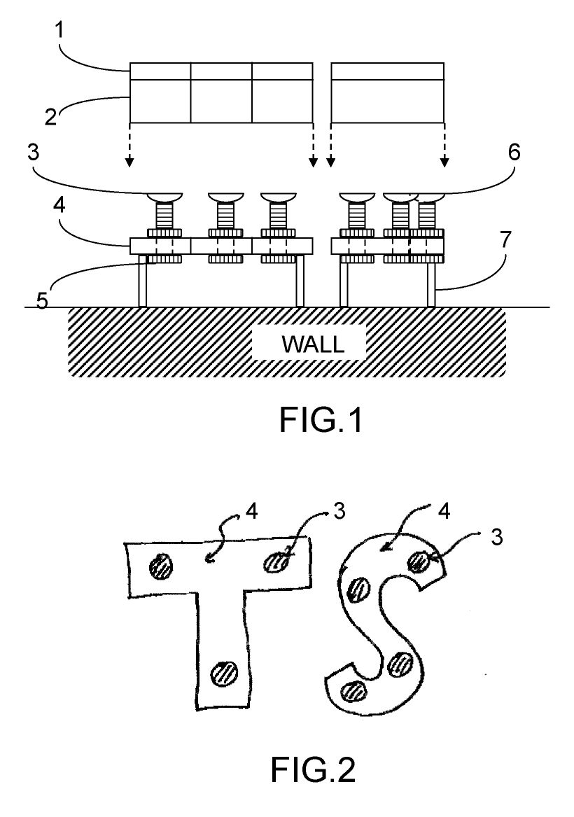

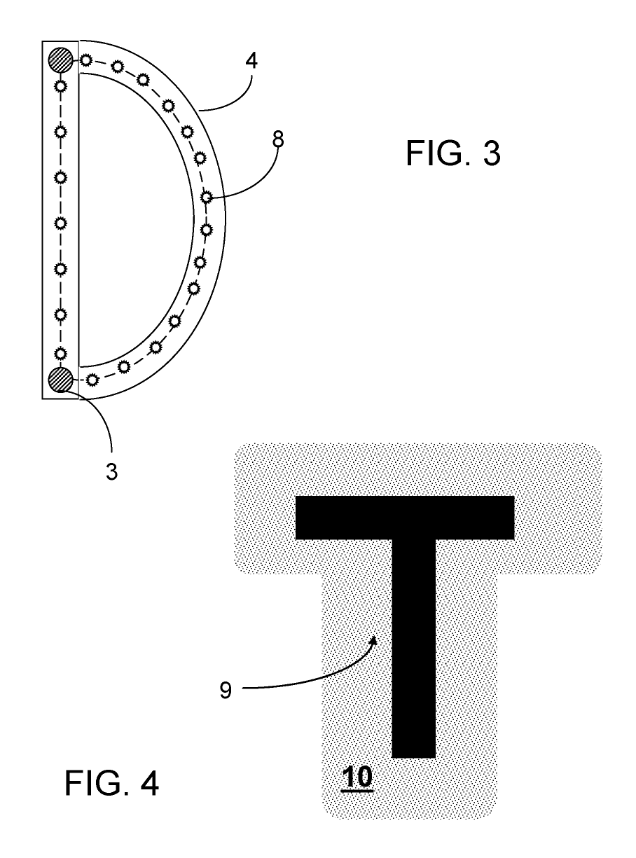

The letter assembly on the left shows the letter itself in the process of being placed onto the mounting plate. FIG. 2 is a top plan view of the two mounting plates of FIG. 1. FIG. 3 is a top plan view of the bottom mounting plate of FIG. 1. FIG. 4 is a top plan view of the letter assembly mounted on a surface.

### DETAILED DESCRIPTION OF THE INVENTION

The drawings in FIGS. 1 and 2 have the following numeric designations:
1. A galvanized sheet of metal that is glued to the letter's inside surface. This is not required if the letter itself is magnetic.
2. The letter
3. Magnetic heads
4. The mounting plate upon which the letter is mounted.
5. Bolts to hold the magnets to the mounting plate.
6. Magnets holding letter to the mounting plate.
7. Fasteners

In order to hide exposed side fasteners on a decorative letter, magnets 6 are mounted on the mounting plate 4 using standard fasteners 7 that hold the mounting plate to the wall. The magnets 6 comprise magnetic heads 3. The letter 2 is magnetically attached to the mounting plate by positioning the galvanized sheet 1 over the mounting plate so as to hold the assembly together with no exposed fasteners. The mounting plate 4 is smaller than the letter 2. The letter can be adjusted or realigned if the mounting plate 4 was placed on the wall incorrectly or crooked. In the figures, the letters “T” and “S” are shown.

FIG. 3 is a top plan view of mounting plate 4. A chain of LED lights 8 are strung in series using an electric wire and fastened securely to the top of the mounting plate. The magnetic heads 3 are visible from the top of the mounting plate. Here, the mounting plate for the letter “D” is shown. The letter 2 (not shown) is then placed over mounting plate 4 and is held in place by the magnets 3.

FIG. 4 is a top plan view of the effect created by the backlit letter “T” mounted to a surface. The letter assembly 9 is mounted to the surface upon which a halo of light 10 appears. The letter itself appears to be dark on a halo-lit background.

I claim:

1. A display sign for mounting on a surface, said sign comprising at least one discreet character that is separately mounted on the surface, wherein each character comprises:
a) a mounting plate that approximates the shape of the character;
b) fasteners that secure the mounting plate to the surface at a desired distance from the surface;
c) at least one magnetic assembly that is secured to the mounting plate, wherein each assembly further comprises a magnetic head; and,
d) a removable magnetic covering comprising at least two faces, wherein said covering is larger than the mounting plate, has the shape of the character, and is designed to fit firmly over the mounting plate and to be held in-place by the action of the magnetic head or heads on the face closest to the mounting plate.

2. The display sign of claim 1 wherein the magnetic head or heads is not in direct contact with the mounting plate.

3. The display sign of claim 1 wherein the covering is fabricated from a non-magnetic material and is caused to be magnetic by attaching a magnetic material to a face of the covering.

4. The display sign of claim 1 further comprising a light source attached either to the mounting plate or to the face of the covering closest to the mounting plate.

5. The display sign of claim 4 wherein the light source comprises an electrically interconnected string of light emitting diodes.
